(19) United States
(12) Patent Application Publication
(10) Pub. No.: US 2007/0131757 A1
(43) Pub. Date: Jun. 14, 2007

(54) Method and system for error detection in an automated teller machine

(76) Inventors: Andrew Robert Hamilton, Dundee (GB); Stephen Neil MacPhail, Dundee (GB); Wolf-Dieter Rossmann, Forfar (GB)

Correspondence Address: JAMES M. STOVER;NCR CORPORATION, 1700 SOUTH PATTERSON BLVD, WHQ4, DAYTON, OH, 45479, US

(21) Appl. No.: 11/297,212

(22) Filed: Dec. 8, 2005

(51) Int. Cl. G07F 19/00; G06Q 40/00

(52) U.S. Cl. 235/379; 705/43

(57) ABSTRACT

The invention features a method for administering an ATM. One or more transactions are conducted at the ATM and the ATM generates one or more logs corresponding to the transactions. A communications link is established between the ATM and a computer. The logs are represented in an XML-based format and are transmitted over the communications link in that format. XML stands for extensible Markup Language.

### BACKGROUND

Automated teller machines (sometimes abbreviated as ATMs) can be configured to allow users to perform various financial transactions at any time. For example, many banks have one or more ATMs from which users may withdraw cash from a checking or savings account that corresponds to a card provided by the user. ATMs can also include devices called financial self-service terminals and kiosks. ATMs can perform one or more of a large number of customer transactions in addition to simply withdrawing cash such as depositing cash or checks in an account, checking the balance in an account, and transferring funds between accounts. ATMs can also perform one or more of a large number of administrative transactions including updating ATM software and replenishing the cash supply of the ATM.

When a transaction is proposed by a user, an ATM may initiate communications to determine whether to complete the proposed transaction or refuse the transaction. For example, a user could request that a large amount of cash be withdrawn from an account. The ATM can communicate the amount and the account to a computer that will check whether the account has sufficient funds. The ATM can then provide the cash if it receives a communication that corresponds to completing the transaction. On the other hand, the ATM can display a message that the transaction cannot be completed if it does not receive the required communication.

After the transaction is completed, the ATM may initiate communications to share the transaction information. As one example, after a customer has withdrawn cash from a bank account, the ATM may send a message detailing the transaction to the bank. As a result, the bank can modify the account balance to reflect the withdrawal. If the bank does not modify the balance in an amount equal to the amount provided in cash by the machine, the customer will experience either a windfall or a loss.

Many ATMs keep records of the transactions that occur at the ATM. The collection of transaction records is often called a log. For example, a log of a withdrawal may include one or more of the following types of information: the bank, the account number, the amount, the time, the location, any exceptions, any user irregularity, and any suspected fraud. Conventional logs are recorded on a paper roll called a journal or as a text file stored at the ATM. Efficient access to the log can be important to detecting and correcting errors. The log of the transaction can confirm the description of the transaction by the customer or the effect of the transaction at the financial institution.

### SUMMARY

In general, in one aspect, the invention features a method for administering an ATM. One or more transactions are conducted at the ATM and the ATM generates one or more logs corresponding to the transactions. A communications link is established between the ATM and a computer. The logs are represented in an XML-based format and are transmitted over the communications link in that format. XML stands for eXtensible Markup Language.

In general, in another aspect, the invention features a system for administering an ATM. The system includes an ATM capable of conducting one or more transactions and generating one or more logs corresponding to the transactions. The system also includes a communications link coupled to the ATM and a computer. The ATM is configured to transmit the logs over the communications link in an XML-based format.

In general, in another aspect, the invention features software for administering an ATM. The software includes instructions that-cause a computer to conduct transactions at the ATM and generate one or more logs corresponding to the transactions. The software provides the logs in an XML-based format and transmits them to a computer over a communications link.

### BRIEF DESCRIPTION OF THE DRAWINGS

FIG. 1 is a diagram of a system for administering an ATM according to one exemplary embodiment.

FIG. 2 is a diagram of a system for administering an ATM according to one exemplary embodiment.

FIG. 3 is a data diagram for an ATM log represented in an XML-based format according to one exemplary embodiment.

FIG. 4 is a flow chart of a method for administering an ATM according to one exemplary embodiment.

### DETAILED DESCRIPTION

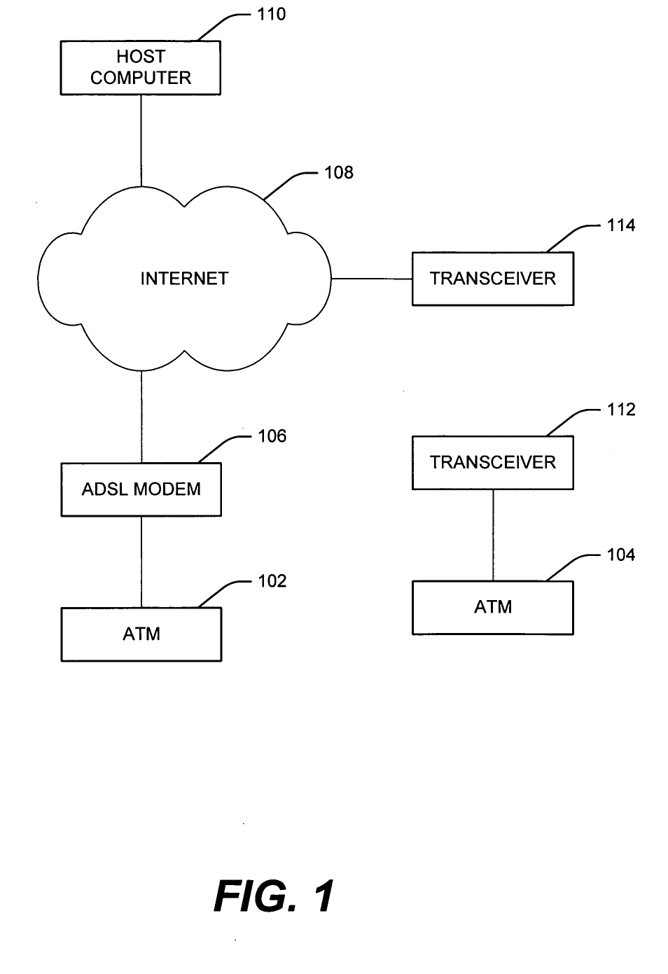

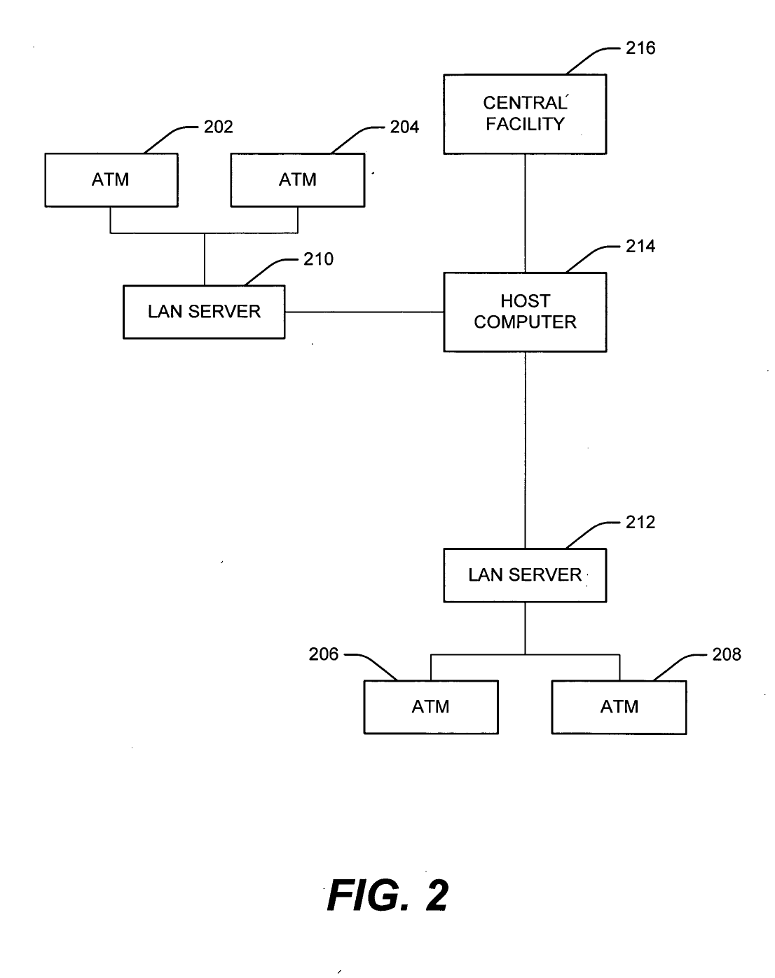

The ATM error detection technique disclosed herein has particular application, but is not limited, to groups of ATMs that are networked together for central administration. FIGS. 1 and 2 illustrate different embodiments of system configurations for administering ATMs in a manner that provides error detection through transmission of log information. Those systems are exemplary and many different systems for coupled a computer to a ATM using a communications link can be utilized with various communications technologies.

In FIG. 1, the system 100 includes two ATMs 102, 104, each with a communications link to a host computer 110. In the FIG. 1 embodiment, the host computer is coupled to the Internet 108. ATM 102 communicates with a computer in the Internet 108 over an Asymmetric Digital Subscriber Line (ADSL) using an ADSL modem 106. ATM 104 communicates with a computer in the Internet 108 over a wireless connection established by two transceivers 112, 114 that exchange electromagnetic waves that are modified in a predetermined manner to indicate information. While ATMs 102, 104 may have different data transfer rates, each is coupled to the host computer 110 through a communications link that includes the Internet 108.

In FIG. 2, the system 200 includes four ATMs 202, 204, 206, 208 which are organized into two groups of two. Each group of ATMs is associated with a LAN server 210, 212 (LAN is an acronym for Local Area Network). System 200 can be used when multiple ATMs are associated with particular physical locations. For example, a bank or a shopping mall may have two or more ATMs. The first group of ATMs 202, 204 are coupled to LAN server 210. As one example, the ATMs 202, 204 can use an ethernet protocol (such as Ethernet, 100Base-T, or Gigabit Ethernet) and architecture to route messages to and from the LAN server 210. Other LAN protocols and architectures can also be used. The second group of ATMs 206, 208 are couple to LAN server 212. The LAN servers 210, 212 are coupled to the host computer 214, for example in a Wide Area Network (WAN). The communications between the LAN servers 210, 212 and the host computer 214 can travel through a public network such as the telephone system or the Internet. The communications between the LAN servers 210, 212 and the host computer 214 can also travel through private telecommunications devices such as a leased line or a satellite. While system 200 shows only two LAN servers 210, 212, additional LANs with two or more ATMs could be added. For example, a banking company may have hundreds of branches with each branch including one or more ATMs that are connected to a LAN for that branch. A LAN server employed with a particular bank branch can be called a branch controller. The LAN need not be dedicated to the ATMs. For example, computers used by branch employees may also be connected to the LAN and the WAN to send and receive information. As an alternative embodiment, the ATMs 202, 204 may only send information to the LAN server 210 and not to the host computer 214. An employee of the branch with LAN server 210 can then determine whether to send a group of ATM communications on to the host computer 214 or an automatic process can be performed, for example at the end of the day. A central facility 216 can also be provided to store information received from the ATMs. For example, the host computer 214 can store information received from the ATMs 202, 204, 206, 208 for a set time period and forward older information to be stored at the central facility 216.

While FIGS. 1 and 2 illustrate particular network configurations, many other configurations are possible. For example, a single ATM may communicate with a single computer through a dial-up link. In other words, the ATM establishes a call only as part of the process for sending a message and does not maintain the call at other times. Such a call can occur over a copper wire connection or using a wireless connection established by a mobile phone as two examples. In addition, many different communications protocols can be used to encode information transmitted from the ATM(s), including but not limited to Transmission Control Protocol/Internet Protocol (TCP/IP), Synchronous Optical NETwork (SONET), and Code Division Multiple Access (CDMA). The information transmitted using these protocols can be compressed prior to transmission using, for example, one of several known compression techniques. The communications hardware includes but not limited to electrical wires or cables, optical cables, and wireless transmitters and receivers.

In one embodiment, the ATMs shown in FIGS. 1 and 2 are accessible by customers for customer transactions. The ATMs can include buttons, a card scanner, or a touch-sensitive screen by which the ATM receive instructions and information from a customer. One example ATM may have a magnetic scanner, a screen, a group of number keys, and a group of buttons next to the screen. The ATM is programmed to have a transaction ready state where a customer can initiate a transaction by inserted a card with a magnetic strip into the magnetic scanner. The ATM can read the magnetic strip to determine what information is on the card. The ATM can then display a request for a code to be entered using the number keys. The ATM can then wait a predetermined amount of time to receive the code. If the correct code is entered, the ATM can then provide transaction options with a graphical indication of the button that corresponds to each option to guide the customer through a transaction. The example ATM with these structures is configured to allow customer transactions in which the ATM both displays information to the customer and receives information from the customer. The same structures can be used to perform administrative transactions. For example, a particular magnetic card and code can be used to initiate a transaction by a bank employee who inserted cash to replenish the ATM.

For some or all transactions, the ATM may keep electronic records of details regarding the transaction. One or more such records form a log. For example, the ATM may have electronic storage in the form of random access memory (RAM), a hard drive, or flash memory. In one embodiment, after a transaction has occurred, a log is formed in the electronic storage with the new record or a log in electronic storage is updated to include the new record. In one embodiment, the log is stored as an object in a particular directory in the file storage structure. Details included in the log can include, but are not limited to, one or more of the following: a banking institution identifier, bank account number, amount of transaction, time of transaction, type of transaction, location of transaction, any exceptions, any errors, any user irregularities, any fraud flags. The log can be stored in an XML-based format. Alternatively, the log can be stored in a different format and converted to XML-based format prior to transmission. The log is sent to another computer over a communication link, such as one of the many discussed above. The XML-based format of the log is then encoded according to the protocol of the communication link. For example, it may be broken into packets to be sent by TCP/IP.

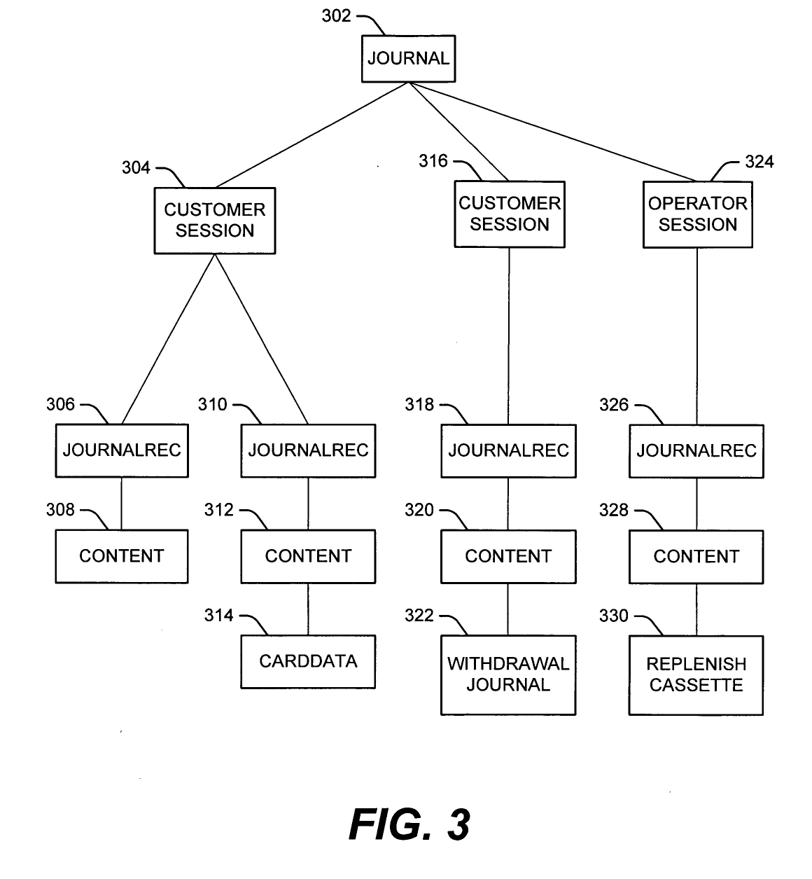

FIG. 3 illustrates the data structure 300 of an example log stored in an XML-based format. The log information is stored in nested tags. Each of the tags can include data and/or tags contained within it. The top level tag is the Journal tag 302. The Journal tag 302 includes two CustomerSession tags 304, 316 and an OperatorSession tag 324. The first CustomerSession tag 304 includes two JournalRec tags 306, 310. The JournalRec tag 306 includes just a Content tag 308, while the JournalRec tag 310 includes a Content tag 312 that includes a CardData tag 314. The second CustomerSession tag 316 includes a JournalRec tag 318, which includes a corresponding Content tag 320. The Content tag 320 includes a WithdrawalJournal tag 322. The OperatorSession tag 324 includes a JournalRec tag 326. The JournalRec tag 326 includes a Content tag 328, which includes a ReplenishCassette tag 330. In one example, when a user performs multiple transactions, the data for each transaction is recorded in a JournalRec tag and the JournalRec tags are included in one CustomerSession or OperatorSession tag. It is possible, but not required, that the log can include data from both customer transactions such as cash withdrawal and administrative transactions such as replenishing ATM cassettes. In the example, data from customer transactions is included in CustomerSession tags, while data from administrative transactions is included in OperatorSession tags. Further tags that are not illustrated in FIG. 3 contain data, but do not contain other tags.

The following is a print out of an example log in an XML-based format. This is just an example of a log file provided as an exemplary embodiment. Logs can be provided in many different forms, including but not limit to forms arranged differently than this example, split up into multiple files, or labeled using different tag names. In the following example, a tag that contains another tag is preceded by a “-” (dash). In an XML file, the dash is not included, but can be added upon display to indicate a tag that has tag contained within it. The tag name begins the tag and is preceded by a “<” (less than symbol) and followed by a “>” (greater than symbol). The tag ends with the tag name preceded by a “/” (forward slash) and surrounded by “<” and “>”.

```
- <Journal>
- <CustomerSession SysTime=“2005-09-05T13:02:58:201”
    T2_PAN=“612345000000001251” TerminalNumber=“66655”>
- <JournalRec>
  <SysTime>2005-09-05T13:02:58:201</SysTime>
  <SeqNum>1</SeqNum>
  <UID>A1</UID>
- <Content>
    </Content>
    </JournalRec>
- <JournalRec>
  <SysTime>2005-09-05T13:02:58:3791</SysTime>
  <SeqNum>2</SeqNum>
  <UID>A2</UID>
- <Content>
- <CardData>
  <T2_PAN t=“String”>612345000000001251</T2_PAN>
  <ExpiryDate t=“DateTime”>31/12/2005 00:00:00</ExpiryDate>
    </CardData>
    </Content>
    </JournalRec>
    </CustomerSession>
- <CustomerSession SysTime=“2005-09-05T13:03:43:1441”
    T2_PAN=“612345000000001251” TerminalNumber=“66655”>
- <JournalRec>
  <SysTime>2005-09-05T13:03:43:1441</SysTime>
  <SeqNum>6</SeqNum>
  <UID>A6</UID>
- <Content>
- <WithdrawalJournal>
  <TransactionPhase t=“String”>PreAuthorise</TransactionPhase>
  <AmountRequested t=“String”>50</AmountRequested>
    </WithdrawalJournal>
    </Content>
    </JournalRec>
    </CustomerSession>
- <OperatorSession SysTime=“2005-09-05T13:07:13:0000” TerminalNumber=“66655”
    OperatorId=“Op125788”>
- <JournalRec>
  <SysTime>2005-09-05T13:03:46:1000</SysTime>
  <SeqNum>9</SeqNum>
  <UID>A9</UID>
- <Content>
- <ReplenishCassette>
  <CassetteId t=“Int32”>1</CassetteId>
  <Notes t=“Int32”>1000</Notes>
  <Denomination t=“Int32”>20</Denomination>
  <Currency t=“String”>USD</Currency>
    </ReplenishCassette>
    </Content>
    </JournalRec>
    </OperatorSession>
    </Journal>
```

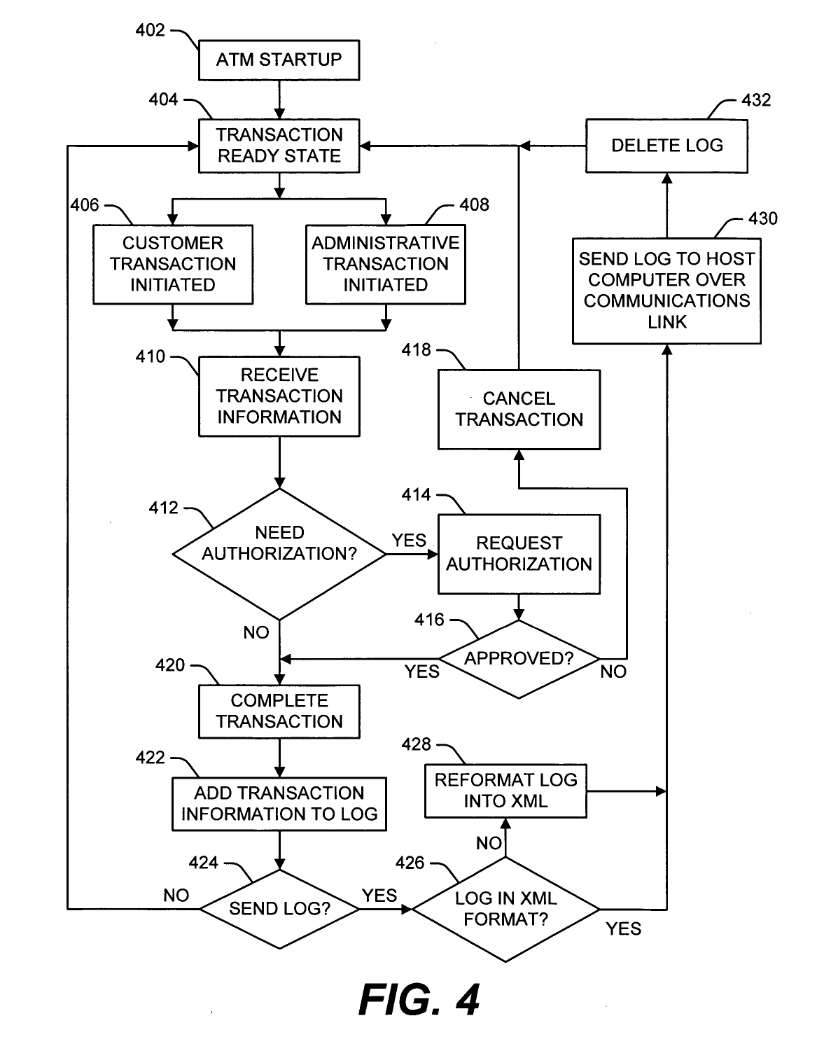

FIG. 4 is a flow chart of a method for administering an ATM according to one exemplary embodiment. The method begins with ATM startup 402, during which the ATM's hardware and software prepares for operation. The ATM then enters a state in which it is ready to conduct transactions 404. For example, the ATM may display a message on its screen stating “insert card to begin.” The ATM can then be used to perform a customer transaction 406 or an administrative transaction 408. The ATM receives information about the specific transaction requested 410. The ATM compares that transaction to a list of transactions or transaction types that require authorization to determine whether authorization is required 412. If authorization is required, it is requested 414 and the if it is not received 416 then the transaction is cancelled 418 and the ATM returns to the transaction ready state 404. If authorization is not required or is received, then the ATM completes the transaction 420. One or more details of the transaction are then added to a log 422. Alternatively, the log may be created to receive the details. The ATM can determine whether to send logs 424 based on a request from the host computer. The host computer can request a log including transactions that meet particular criteria, or may request a log with all currently stored transaction details. In an alternative embodiment, the ATM can be configured to determine whether to send logs 424 based on predetermined rules. For example, an ATM could send a log when it reaches a certain size, after a certain number of transactions, or a certain amount of time. If it is not yet time to send a log, the ATM returns to the transaction ready state 404. In an alternate embodiment, the ATM may return to the ready state immediately after the transaction is completed 420 and add to the log and send it at the same time that it is ready to perform addition transactions. Once the ATM's programming determines that a log should be sent 424, the log is reformatted into XML format 428 if it is not already in that format 426. The log is then sent to a host computer over a communications link 430. After the log has been sent, the ATM's log can, but do not need to be, deleted 432. In one embodiment, deletion occurs in response to a request from the host computer. In another embodiment, deletion occurs automatically after sending. In another embodiment, deletion only occurs as the result of an administrative transaction.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for administering an automated teller machine (ATM), comprising:
conducting one or more transactions at the ATM;
generating one or more logs corresponding to the transactions;
establishing a communication link between the ATM and a computer; and
transmitting the logs from the ATM to the computer over the communication link,
wherein the logs are transmitted in an XML-based format.

2. The method of claim 1, further comprising requesting authorization for at least one of the transactions.

3. The method of claim 1, wherein the one or more logs is one log corresponding to a plurality of transactions.

4. The method of claim 1, wherein the transactions include cash withdrawals.

5. The method of claim 1, further comprising transmitting a request from the computer to the ATM.

6. The method of claim 1, further comprising deleting the one or more logs.

7. The method of claim 1, wherein the communication link includes the Internet.

8. The method of claim 1, wherein the one or more logs include data indicating the time that the transactions occurred.

9. A system for administering an automated teller machine (ATM), comprising:
an ATM configured to conduct one or more transactions and generate one or more logs corresponding to the transactions;
a communication link coupled to the ATM; and
a computer coupled to the communication link,
wherein the ATM is configured to transmit the logs from the ATM to the computer in an XML-based format.

10. The system of claim 9, wherein the ATM is configured to request authorization for at least one of the transactions.

11. The system of claim 9, wherein the one or more logs is one log corresponding to a plurality of transactions.

12. The system of claim 9, wherein the transactions include cash withdrawals.

13. The system of claim 9, wherein the computer is configured to transmit a request to the ATM.

14. The system of claim 9, wherein the ATM is configured to delete the one or more logs.

15. The system of claim 9, wherein the communication link includes the Internet.

16. The system of claim 9, wherein the one or more logs include data indicating the time that the transactions occurred.

17. Computer software, stored on a tangible storage medium, for administering an automated teller machine (ATM), the software comprising executable instructions that cause at least one computer to:
conduct one or more transactions at the ATM;
generate one or more logs corresponding to the transactions; and
transmit the logs from the ATM to a computer over a communication link in an XML-based format.

18. The software of claim 17, further comprising instructions that cause at least one computer to request authorization for at least one of the transactions.

19. The software of claim 17, wherein the one or more logs is one log corresponding to a plurality of transactions.

20. The software of claim 17, wherein the transactions include cash withdrawals.

21. The software of claim 17, further comprising instructions that cause at least one computer transmit a request from the computer to the ATM.

22. The software of claim 17, further comprising instructions that cause at least one computer delete the one or more logs.

23. The software of claim 17, wherein the communication link includes the Internet.

24. The software of claim 17, wherein the one or more logs include data indicating the time that the transactions occurred.
